(19) United States
(12) Patent Application Publication
(10) Pub. No.: US 2008/0204970 A1
(43) Pub. Date: Aug. 28, 2008

(54) Transparent oxide capacitor structures

(75) Inventors: Leonidas E. Ocola, Oswego, IL (US); Krishna K. Uprety, Downers Grove, IL (US); Orlando H. Auciello, Bolingbrook, IL (US)

Correspondence Address: FOLEY & LARDNER LLP, 321 NORTH CLARK STREET, SUITE 2800, CHICAGO, IL, 60610-4764, US

(73) Assignee: UChicago Argonne, LLC

(21) Appl. No.: 11/712,063

(22) Filed: Feb. 28, 2007

(51) Int. Cl. H01G 4/06

(52) U.S. Cl. 361/305

(57) ABSTRACT

A ferroelectric capacitor structure having a lattice matched lanthanide oxide film intervening layer for providing a high polarization state. The capacitor structure includes a glass substrate, a transparent electrode layer disposed on the glass substrate, a lanthanide oxide film disposed on the transparent layer and a ferroelectric perovskite layer disposed on the lanthanide oxide film. The claim also encompases semi-transparent applications where one conductive electrode (top or bottom) is not transparent.

The United States Government has certain rights in this invention pursuant to Contract No. DE-AC02-06 CHI 1357 between the U.S. Department of Energy and UChicago Argonne, LLC as operator of Argonne National Laboratory.

### BACKGROUND OF THE INVENTION

Ferroelectric capacitors are comprised of crystals which can establish and retain a polarized state, making such capacitors capable of storing electric charge or polarization (i.e., displacement of positive and negative charges in the lattice of the material, in opposite directions, thus establishing electrical dipoles). This polarizability of ferroelectric capacitors is currently being used in commercial non-volatile ferroelectric random access memories (FeRAMs), and micro and nano-scale transducers, sensors and actuators. Polarizable surfaces of ferroelectric layers can also be used for controlling fluid motion at the nanoscale and manipulating charged biomolecules Many of these devices will benefit from the fabrication of whole transparent capacitors, when fluorescence spectroscopy is required and light needs to pass through the devices. Other important applications enabled by transparent ferroelectric capacitor include high-performance solar energy storage and photovoltaic devices, and intelligent coatings for industrial and residential windows to control ambient temperature inside buildings and houses. In relation to those applications described above and many others, highly transparent Pb(Zr0.52Ti0.48)O3 (“PZT”) films will enable many of the proposed devices. However, the PZT layers will need to be deposited on a transparent electrical conducting layer, and a second transparent electrode layer will need to be deposited on top of the PZT layer to complete the capacitor structure, and to facilitate voltage application to change polarization direction in the ferroelectric layer of the capacitor. A common transparent electrode layer extensively used in the industry is indium-tin-oxide (ITO). transparent ITO layers can be deposited by physical vapor and metalorganic chemical vapor deposition methods, and by conventional chemical solution deposition process on different transparent substrates that can sustain the temperatures needed for producing the perovksite crystallographic structure that exhibit ferroelectricity. PZT film-based capacitors fabricated by growing PZT layers on ITO electrode layers on glass have yielded polarization of up to 36.3 μC/cm², as reported in the literature). PZT films grown on ITO layers on glass substrates are highly transparent and exhibit device compatible properties due to the high conductivity of the ITO bottom electrode. However, due to the large lattice mismatch between PZT (a.=0.404 nm) and ITO, (a.=1.022 nm), the crystal texture of the PZT films grown on ITO layers is relatively poor, resulting in relatively low polarization, thus poor capacitor performance

### SUMMARY OF THE INVENTION

The present invention relates generally to the production of highly transparent ferroelectric capacitors and methods for manufacture. Particularly, this invention relates to new materials integration strategies to produce highly transparent ferroelectric capacitors fabricated via growth of transparent ferroelectric films on an arbitrary conductive transparent electrodes, e.g. indium tin oxide (“ITO”), with an intervening layer that may have less or higher conductivity, but exhibiting the critical feature of good lattice match to the ferroelectric layer, to induce growth of highly (001) oriented PZT layers, thereby yielding the highest polarizability associated with the main polarization direction in PZT (i.e., the (001 direction). In a representative form of the invention, the ferroelectric Pb(Zr,Ti)O₃ (“PZT”) layer is grown on an intervening thin film of LaNiO₃ (“LNO”), grown on top of ITO, to achieve a highly transparent ferroelectric PZT capacitor with optimized high polarization. The transparent PZT film-based capacitors can then be used as components of the multifunctional devices described hereinbefore, including without limitation, FeRAMs, sensors, transducers, actuators, switches, photovoltaic devices and also for nanotechnology applications, such as nanofluidic devices.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a cross section of a layered structure constructed in accordance with a preferred form of the invention;

FIG. 2 shows comparative diffraction patterns of layered structures of PZT/LNO/ITO on glass and PZT/ITO on glass;

FIG. 3A shows an atomic force microscope scan of the surface of PZT layer deposited on LNO; FIG. 3B shows a scan of PZT layer deposited on ITO;

FIG. 4A shows a PZT layer 45 nm thick, exhibiting a diffraction pattern characteristic of a rhombohedral phase with a (200) texture; FIG. 4B shows a PZT layer 90 nm thick exhibiting a diffraction pattern of a tetrahedral phase;

FIG. 5 shows light transmission spectra for various combinations of ITO, LNO, and or PZT layers; and

FIG. 6A shows a polarization (P) versus electric field (E) hysteresis loop for a layered structure of PZT/LNO/ITO fabricated on glass and FIG. 6B shows dissipation versus voltage for the PZT/LNO/ITO/capacitor fabricated on glass.

### DETAILED DESCRIPTION OF THE PREFERRED EMBODIMENTS

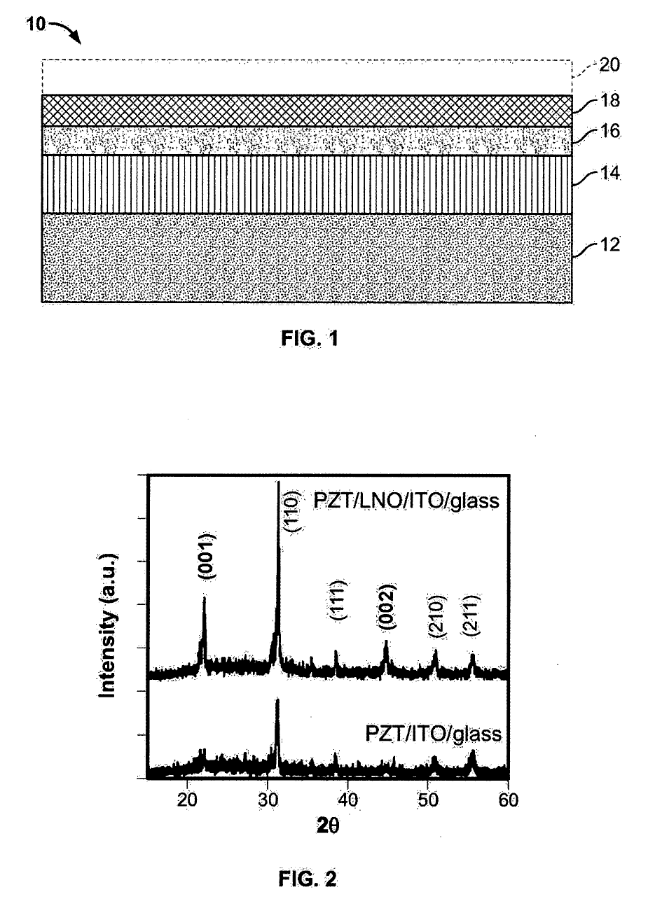

In a representative form of the invention shown in FIG. 1, a layered structure 10 comprises a substrate 12, on bottom electrode such as ITO layer 14, a thin interviewing film 16 and a ferroelectric layer 18. In exemplary embodiments, a completed device for application may have numerous other attached layers, such as top layer 20 shown in phantom in FIG. 1. The top layer is preferred to be the symmetric transparent layer structure as a top intervening layer such as layer 16 and a top electrode like layer 14, or can be non-transparent for semitransparent capacitor applications. The substrate 12 is preferably an amorphous layer, such as glass, but can also be other suitable substrates, including crystalline transparent substrates such as SrTiO₃, which enable deposition of the desired bottom electrode, such as ITO layer 14. In a representative embodiment the glass substrate 12 comprises an ITO-buffered glass substrate (such as is provided by Delta Technologies) but can be any conventional substrate compatible with a transparent bottom electrode such as the ITO layer 14. The thin intervening film 16 should be a conductive metallic electrode, such as for example, SrRuO3 (“SRO”) or LaNiO3 (“LNO”) or other appropriate lanthanide series oxides, or similar conducting oxide, which should have a good lattice match with the ferroelectric capacitor layer 18.

In the most preferred form of the invention, the ferroelectric capacitor layer 18 comprises a Pb(Zr,Ti)O₃ (“PZT”) layer and most preferable consists essentially of Pb(ZrₓT₁₋ₓ)O₃, where x can vary from 0 to a 1.0 However, other transparent ferroelectric layers, such as BaTiO₃, SrBi₂Ta₂O₉, or any other can be used instead of PZT, The resulting layered structure 10 includes the ITO layer 14 which has a cubic structure with lattice parameter a=1.022 nm, the LNO film 16 with a perovskite pseudocubic lattice structure and a ˜0.383 nm. The PZT layer 18 is also a perovskite pseudocubic lattice structure with a ˜0.404 nm, which provides the type of small lattice mismatch resulting in good crystalline texture for the PZT layer 18, high transparency and high polarization. The intermediate LNO layer 16 has the same crystalline structure as the PZT layer 18, with a lattice constant that creates a strain of about 5% to the PZT structure. While not limiting the scope of the invention, it is believed this strain is enhancing the polarization value of the PZT layer. LNO is thin enough that the electrons quickly move from the ferroelectric crystal to the very conductive electrode (ITO in this case). The layered structure 10 can be coupled to an electric field source (not shown) for use in any of the various applications described herein.

The layered structure 10 can be prepared by a variety of conventional methodologies known in the industry (e.g., physical and metalorganic chemical vapor deposition) and in a preferred form of this invention the PZT layer 18 was deposited by chemical solution deposition with the LNO intervening film 16 and the ITO layer 14. Further details of the preferred method of preparation are set forth hereinafter in the Example.

The deposited layered structure 10 was examined by various methodologies, including X-ray diffraction (XRD), atomic force microscopy, optical transmittance using a conventional double beam spectrophotometer and a DC magnetometer for characterization of ferroelectric polarization. The resulting remnant polarization, Pr, of the PZT layer 18 was about 52 μC/cm² which is about 30% more than the best polarization (36.3° C./cm²) reported for conventional transparent PZT film. The layered structure 10 also has very good conductivity as a result of using the LNO film 16 as the bottom electrode. The polarization characteristics of the PZT layer 18 were measured using a good metal conductor, such as palladium as the top electrode, where the top electrodes were patterned as circular layers.

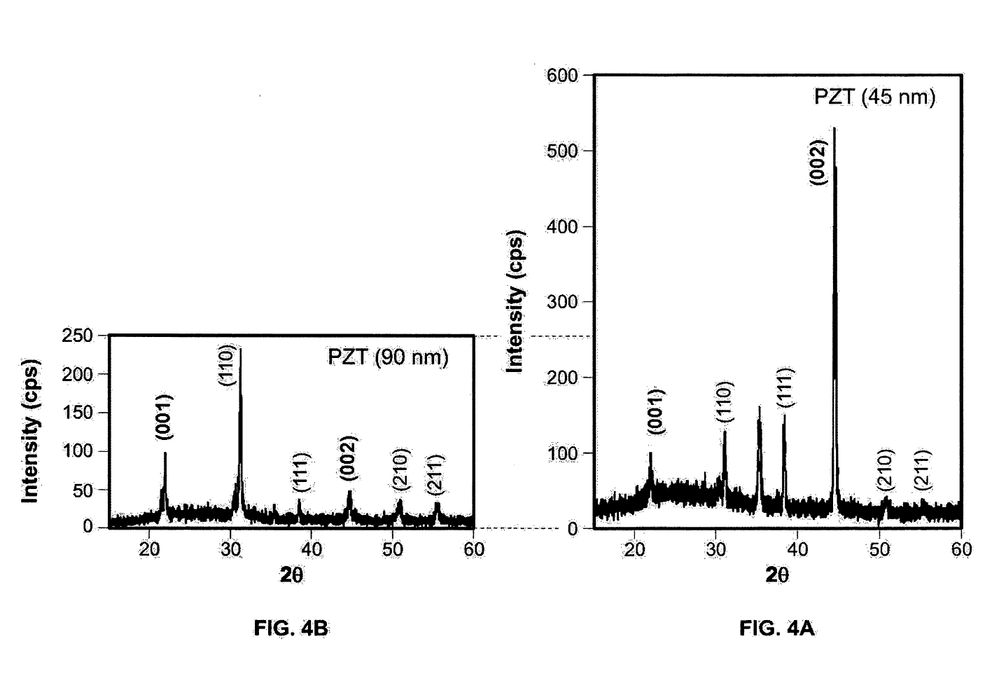

X-ray diffraction examination was carried out on the layered structure 10, and the results are shown in FIG. 2 for a structure with and without the LNO film 16, and in FIG. 4A and FIG. 4B for different thicknesses of the PZT layer on the LNO film. The preferred orientations for high polarization for PZT are (001) and (002). In one embodiment, the (110) orientation is not favorable for high polarization of the PZT. The presence of clear PZT diffraction peaks of (001), (110) and (111) show the polycrystallinity of the PZT layer 18 deposited on the ITO buffered glass substrate 12 with the intervening LNO film 16. In addition, the strong peak at 20=32° is indicative of a preferred (110) orientation for the PZT layer 18. In particular the higher overall intensity of the (001) and (002) peaks for the PZT/LNO/ITO/glass layered structure 10 shows the improved texture compared to the PZT/ITO/glass layer arrangement without the LNO film 16. The improved texture of the PZT/LNO/ITO/glass layered structure 10 can be attributed to the good lattice match of the LNO film 16 with the PZT layer 18, whereas the very poor texture of the PZT/ITO/glass combination (shown in the lower part of the diffraction data of FIG. 2) is related to the large lattice mismatch between the PZT layer 18 and the ITO layer 14.

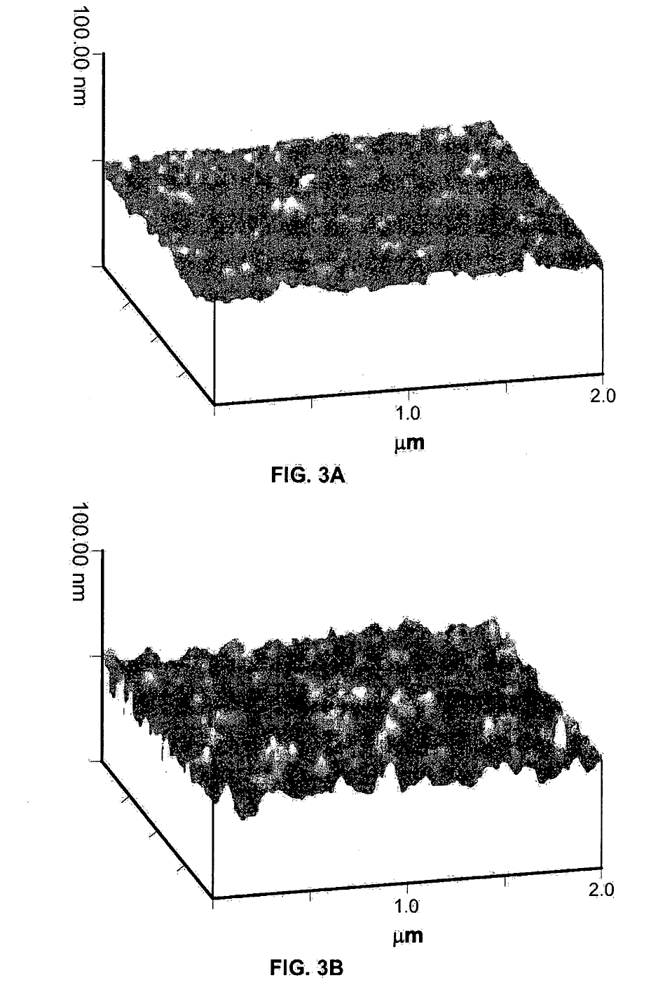

The surface morphology is quite different comparing a structure of the LNO film 16/ITO layer 14/glass substrate 12 with a structure of the ITO layer 14/glass substrate 12 as can be seen in the atomic force microscopy (“AFM”) micrographs of FIGS. 3A and 3B. The mean square surface roughness (rms) of a structure of the LNO film 16/ITO layer 14/glass substrate 12 and a structure of the ITO layer 14/glass substrate 12 was 17.85 and 38.22 nm, respectively. Because of this improved surface roughness for the structure having the LNO film 16, namely the layered structure 10 of the LNO film 16/ITO layer 14/glass substrate 12, the result is a much smoother deposited PZT layer 18. This, in turn, provides an excellent interface between the PZT layer 18 and the top electrode, such as metallic palladium or other suitable electrode, including LNO or LNO/ITO heterostructure, symmetric with the bottom electrode structure. Either of the optimized electrode layer combination may result in high polarization and overall electronic transport properties of the layer structure 10 and the ferroelectric PZT layer 18.

The crystalline structure of the PZT layer 18 can also be altered controllably for further refinement, adjustment or modification of the ferroelectric and optical properties by changing layer thickness. This can be noted in FIG. 4A in which the PZT layer 18 is a rhombohedral structure 45 nm thick and exhibits optimum polarization with a preferred (002) and (001) planar orientation texture. In a 90 nm thick PZT layer 18, FIG. 4B, the crystalline phase has some significant (001) and (002) structure, but also exhibits a tetrahedral phase with dominant (110) orientation not optimal for polarization. One can, if needed, or desirable, deposit superlattice layers of different crystalline structures to achieve a special desired polarization property. When the PZT layer 18 is deposited directly onto the ITO-buffered glass substrate 12, FIG. 2, the crystal structure is dominated by the tetrahedral phase (110) orientation independent of PZT layer 18 thickness.

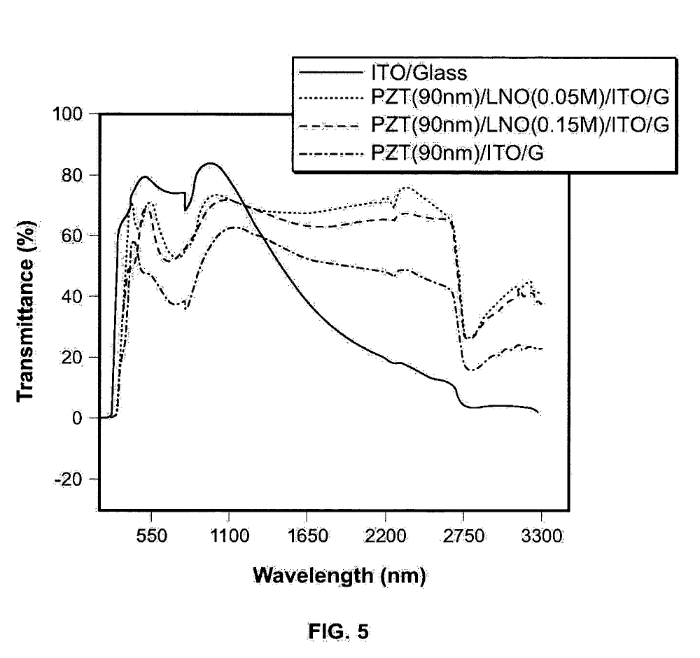

Optical transmittance properties are shown in FIG. 5. Shown for comparison are data for the ITO layer 14/glass substrate 12 and the layered structure 10 of the PZT layer 18/LNO film 16/ITO layer 14/glass substrate 12. The PZT layer 18/LNO film 16/ITO layer 14/glass substrate shows excellent transmittance (about 59%) within the viable light range, and this is close to the 69% transmittance of the layered arrangement of the PZT layer 18/glass substrate 12. This transmittance property can be quite critical in certain applications, such as bio-imaging and photovoltaic devices wherein high transparency for the PZT layer 18 is essential.

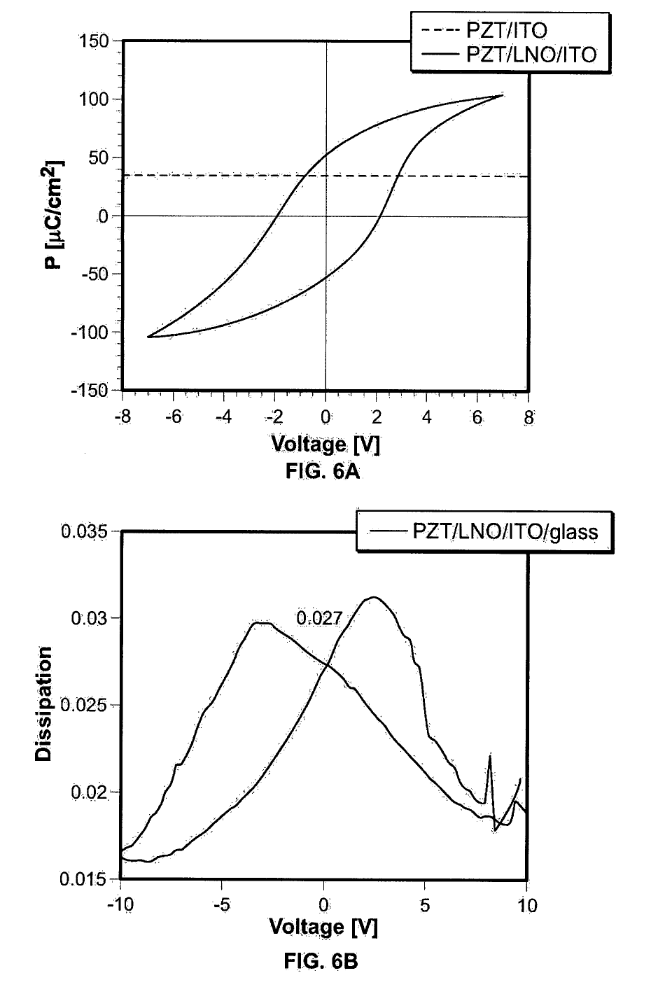

The polarization properties are illustrated in FIG. 6A which shows polarization for a hysteresis loop for the PZT layer 18/LNO film 16/ITO layer 14/glass substrate 12. The layered structure 10 of FIG. 6A shows a Pr of 52 μC/cm² while the dashed line for the PZT layer 18/ITO layer 14/glass substrate is a flat value of 36 μC/cm². Each structure used a top electrode of palladium. The improved Pr of the layered structure 10 can be associated with the good lattice match achieved by introduction of the LNO film 16 to achieve good crystallographic texture for the polycrystalline PZT layer 18 in combination with the good electronic conduction properties of the ITO layer 14. The dissipation factor, δ, of the layered structure 10 was measured at 10 kHz and is shown in FIG. 6B. For the layered structure 10, the dissipation factor was very low (0.027).

LNO and ITO have been tested separately as bottom electrodes. In the case of LNO, it was observed that the thickness of LNO on glass substrate must exceed 200 nm in order to achieve good electrical conductivity. However, as the thickness of LNO increase beyond a certain limit, the LNO film becomes non-transparent. In the case of ITO, the PZT film is highly transparent but polycrystalline, as shown above with the XRD data, because of the large lattice mismatch between PZT and ITO. As a result the remnant polarization Pr is low. Thus, to maintain good crystalline texture of PZT with a good transmittance and excellent electrical properties, our experimental results suggest that a thin film (<70 nm) LNO and ITO should preferably be used together to grow a transparent PZT layer with high polarization.

The resulting layered structure 10 has numerous applications described hereinbefore, including digital electronic uses, solar energy device and biomedical uses such as for control of fluid motion at the nanoscale level using polarization properties to actuate biological nanovalves to open or close channel flow.

The following non-limiting example illustrates one method of preparation of the layered structure 10.

### EXAMPLE

The solution for the growth of LNO films was prepared using lanthanum nitrate hexahydrate (strem 99.999%) and nickel acetate tetrahydrate (aldric 99.998%) as precursor materials along with 2 methoxyethanol [2MOE] (aldric 99.9%) as a solvent. The powders were dissolved in solvent by the use of heating and stirring in a flask. The solution was then transferred to the container using a 0.2 μm filter. Commercially available ITO coated glass (1″×1″ with thickness 200 nm) was used as a substrate, although all oxide layers can be grown by any of the film deposition methods described above. Prior to deposition of LNO, the glass substrates were cleaned with acetone and methanol. The LNO layer (70 nm thick) was deposited using a spin coating unit at a speed of 3000 rpm for 30 seconds. The wet film was pyrolized immediately in air at 450° C. for 15 min followed by crystallization of the pyrolized film by annealing in air at 650° C. for 20 min.

The PZT solution was prepared using Pb acetate tetrahydrate (aldric 99%), Zr-propoxide (aldric 97%) and Ti-isopropoxide as precursors materials and 2 methoxyethanol [2MOE] (sigma 99.9%) as a solvent. The molar ratio Zr/Ti was kept at 52/48 and 20% excess lead was used to compensate Pb loss due to volatilization produced during annealing. The Zr-propoxide as a starting material was mixed with 2MOE in a flask by stirring. Ti-isopropoxide was then added to the above solution and stirred. Finally, the Pb (II) acetate trihydrate (Sigma-Aldric 97%) was dissolved into the solution by heating at 100° C. for 1 hr coupled with stirring. The PZT layer (90 rpm thick) was then deposited on the LNO-coated ITO/glass substrate at a speed of 3000 rpm for 30 seconds. The wet film was pyrolized by heating in air at 450° C. for 5 min and then crystallized by annealing at 650° C. for 20 min in air.

The texture of the PZT film was studied by X-ray diffraction [XRD], using a Philip diffractometer. The surface roughness of LNO films was studied by atomic force microscopy [AFM] (DI-3000). Optical transmittance of the PZT films was measured using a double beam UVPC spectrophotometer (Shimadzu Model 1601). For ferroelectric characterization, Pd top electrodes were deposited on PZT with the help of a shadow mask using a DC magnetometer system (AJA international). The typical thickness of the Pd electrodes was 100 nm and the electrode diameter for electrical characterization was 100 μm. Polarization hysteresis vs. electric field loops of the ferroelectric capacitor was measured using a RT 6000HVA high voltage measurement system and the dissipation factor (tan δ) of the film was measured at 10 kHz using a HP4192A low frequency analyzer.

It should be understood that the above description of the invention and specific example and embodiments, while indicating the preferred embodiments of the present invention are given by demonstration and not limitation. Many changes and modifications, including use of other transparent ferroelectric and electrode layers within the scope of the present invention may therefore be made without departing from the spirit thereof and the present invention includes all such changes and modifications.

What is claimed is:

1. A transparent ferroelectric capacitor structure, comprising:
a substrate;
a transparent electrode layer selected from the group consisting of an indium tin oxide, a transparent conductive oxide and a transparent electrode layer disposed on the substrate;
a lanthanide oxide film disposed on the transparent electrode layer; and
a ferroelectric perovskite layer disposed on the lanthanide oxide film.

2. The capacitor structure as defined in claim 1 wherein the ferroelectric perovskite layer comprises Pb (Zr, Ti) O₃, or BaTiO₃.

3. The capacitor structure as defined in claim 2 wherein the Pb (Zr, Ti) O₃ comprises a non-stoichiometric oxide.

4. The capacitor structure as defined in claim 3 wherein the non-stoichiometric oxide consists essentially of Pb (Zr_{0.52} Ti_{0.48}) O₃.

5. The capacitor structure as defined in claim 1 where the lanthanide oxide film comprises at least one of SrRuO₃ and La NiO₃.

6. The capacitor structure as defined in claim 1 wherein the substrate comprises an amorphous material.

7. The capacitor structure as defined in claim 6 wherein the amorphous material comprises a glass.

8. The capacitor structure as defined in claim 7 wherein the glass is selected from the group consisting of an indium tin oxide coating, a transparent conductive oxide and a transparent electrode.

9. The capacitor structure as defined in claim 2 wherein the lanthanide oxide film comprises a layer of thickness less than about 100 nm.

10. The capacitor structure as defined in claim 1 wherein the remnant polarization, Pr, is about 52 μC/cm².

11. The capacitor structure as defined in claim 1 further including a top metallic or transparent conductive layer.

12. The capacitor structure as defined in claim 11 wherein the top metallic conductive layer comprises palladium or the same materials that comprise the bottom transparent electrode

13. The capacitor structure as defined in claim 2 wherein the Pb (Zr, Ti) O₃ comprises selectably a rhombohedral crystalline structure and a pseudo-cubic crystalline structure.

14. The capacitor structure as defined in claim 1 further including an electric field source to implement use of the ferroelectric capacitor for selected applications.

15. A layered structure for effecting polarization based functionalities, comprising:
a glass substrate;
an indium tin oxide layer disposed on the glass substrate;
a conductive metallic bottom electrode disposed on the indium tin oxide layer;
a Pb (Zr, Ti) O₃ layer disposed on the conductive metallic bottom electrode; and
a top electrode coupled to the Pb (Zr, Ti) O₃ layer.

16. The layered structure as defined in claim 15 wherein the Pb (Zr, Ti) O₃ consists essentially of Pb (Zr_{0.52} Ti_{0.48}) O₃.

17. The layered structure as defined in claim 15 wherein the conductive metallic bottom electrode comprises a conductive lanthanide series oxide substantially lattice matched to the Pb (Zr_{0.52} Ti_{0.48})O₃ layer.

18. The layered structure as defined in claim 15 wherein the glass substrate consists essentially of a conventional glass substrate with a indium tin oxide top layer.

19. The layered structure as defined in claim 17 wherein the lanthanide series oxide is selected from the group consisting of SrRuO₃ and LaNiO₃.

20. The layered structure as defined in claim 15 further including a coupled electric field source for driving the layered structure to effectuate selected applications.
